(19) United States
(12) Patent Application Publication
(10) Pub. No.: US 2026/0338350 A1
(43) Pub. Date: Oct. 29, 2026

(54) LAMP AND METHOD OF MAKING THE LAMP

(71) Applicant: Michael Simon Toon, Venice, CA (US)

(72) Inventor: Michael Simon Toon, Venice, CA (US)

(21) Appl. No.: 19/459,240

(22) Filed: Jan. 26, 2026

Related U.S. Application Data
(60) Provisional application No. 63/794,170, filed on Apr. 24, 2025.

(51) Int. Cl. F21V 1/04; F21V 1/26; F21V 17/10

(52) U.S. Cl. CPC F21V 1/04; F21V 1/26; F21V 17/10

(57) ABSTRACT

A lamp includes a base, a lampshade, a grip structure, a socket, and a power cord. The lampshade is cylindrical and defines an interior shade space. The lampshade includes a top shade panel, a side shade wall is coupled to the top shade panel, and a bottom shade panel is detachably coupled to the side shade wall and positioned abutting the base.

### (B) CROSS-REFERENCE TO RELATED APPLICATIONS

This application claims priority to the provisional application 63/794,170 filed Apr. 24, 2025.

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (E) STATEMENT REGARDING PRIOR DISCLOSURES BY THE INVENTOR OR JOINT INVENTOR

Not Applicable

### (G) BACKGROUND OF INVENTION

### (1) Field of the Invention

The disclosure relates to lamps and more particularly pertains to a new lamp that has does not use a traditional wire shade, but rather includes a spherical base and a cylindrical shade having a side shade wall and top and bottom shade panels made of plastic, such as biodegradable plastic.

### (2) Description of Related Art Including Information Disclosed Under 37 CFR 1.97 and 1.98.

The prior art relates to lamps. The prior art, as best understood, does not disclose a lamp that includes a base, a lampshade, a grip structure, a socket, and a power cord. The base has a top base surface that is flat, a bottom base surface that is flat, and a side base wall that is spherical. The base defines an interior base space. The base includes a top base aperture in the top base surface and a bottom base aperture in the bottom base surface. The lampshade is coupled to the base. The lampshade is cylindrical and defines an interior shade space. The lampshade includes a top shade panel, a side shade wall is coupled to the top shade panel, and a bottom shade panel is detachably coupled to the side shade wall and positioned abutting the top base surface. The bottom shade panel includes a shade aperture that is aligned with the top base aperture to connect the interior shade space and the interior base space. The grip structure is coupled to the base at the bottom base surface. The grip structure includes a friction material on an outer surface of the grip structure to minimize sliding movement of the base on a structure. The base structure includes a channel connected to the bottom aperture. The socket is coupled to the lampshade and the base. The socket is positioned to pass through the shade aperture and the top base aperture. The power cord is coupled to the socket. The power cord is positioned extending through the base and out through the channel.

### (H) BRIEF SUMMARY OF THE INVENTION

An embodiment of the disclosure meets the needs presented above in a lamp generally comprising a base, a lampshade, a grip structure, a socket, and a power cord. The base has a top base surface that is flat, a bottom base surface that is flat, and a side base wall that is spherical. The base defines an interior base space. The base includes a top base aperture in the top base surface and a bottom base aperture in the bottom base surface. The lampshade is coupled to the base. The lampshade is cylindrical and defines an interior shade space. The lampshade includes a top shade panel, a side shade wall is coupled to the top shade panel, and a bottom shade panel is detachably coupled to the side shade wall and positioned abutting the top base surface. The bottom shade panel includes a shade aperture that is aligned with the top base aperture to connect the interior shade space and the interior base space. The grip structure is coupled to the base at the bottom base surface. The grip structure includes a friction material on an outer surface of the grip structure to minimize sliding movement of the base on a structure. The base structure includes a channel connected to the bottom aperture. The socket is coupled to the lampshade and the base. The socket is positioned to pass through the shade aperture and the top base aperture. The power cord is coupled to the socket. The power cord is positioned extending through the base and out through the channel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a lamp according to an embodiment of the disclosure.

FIG. 2 is an exploded perspective view of an embodiment of the disclosure.

FIG. 3 is a perspective view of an embodiment of the disclosure.

FIG. 4 is a bottom perspective view of an embodiment of the disclosure.

FIG. 5 is a top view of a component of an embodiment of the disclosure.

FIG. 6 is a top view of a component of an embodiment of the disclosure.

FIG. 7 is an exploded view of an embodiment of the disclosure.

FIG. 8 is a side cross-sectional view of an embodiment of the disclosure in use.

FIG. 9 is a side cross-sectional view of an embodiment of the disclosure.

FIG. 10 is an exploded perspective view of an embodiment of the disclosure.

### (J) DETAILED DESCRIPTION OF THE INVENTION

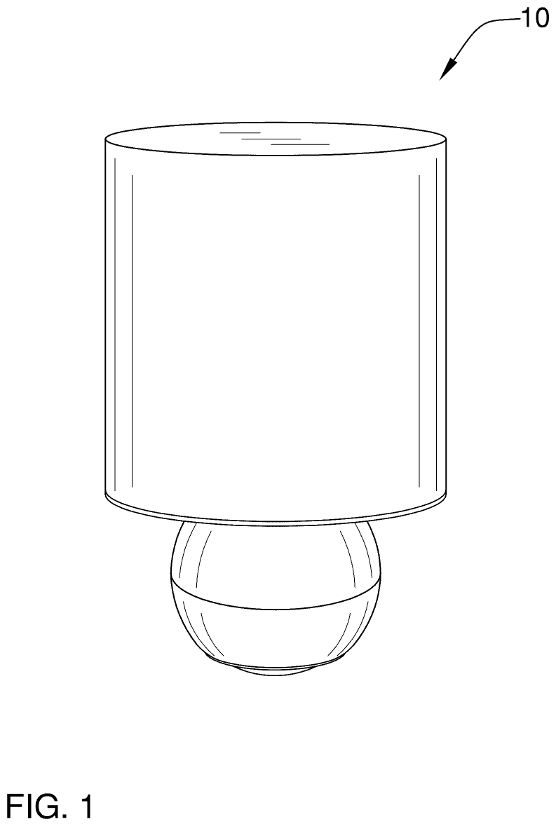

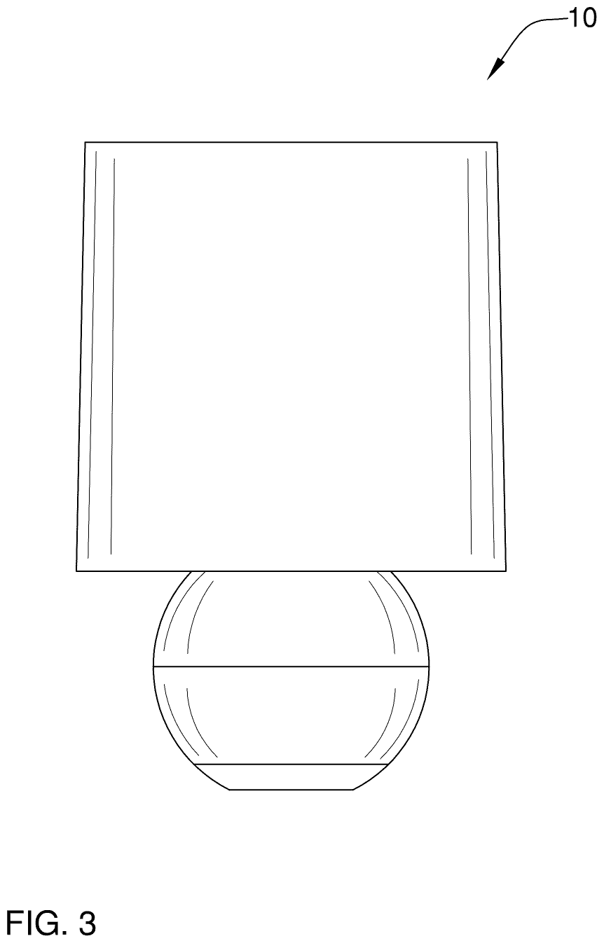

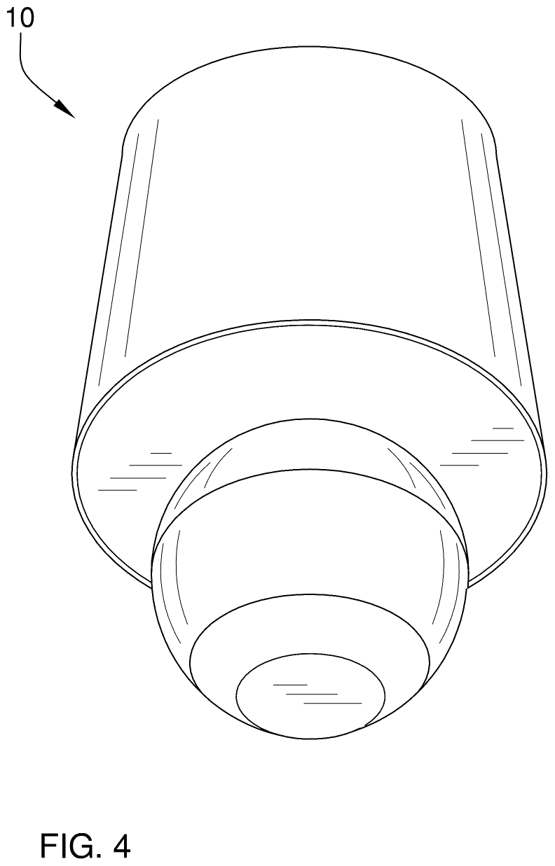

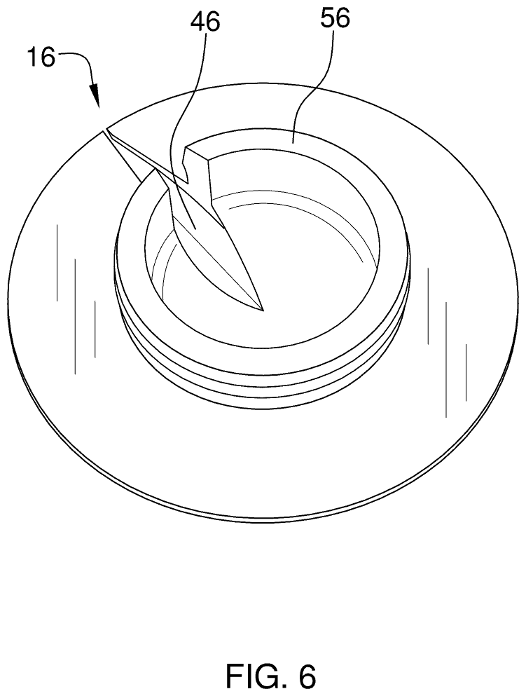

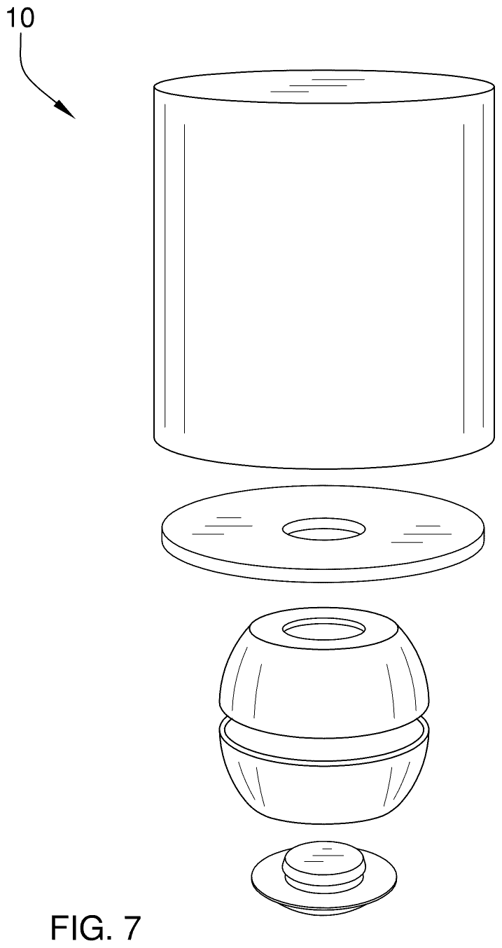

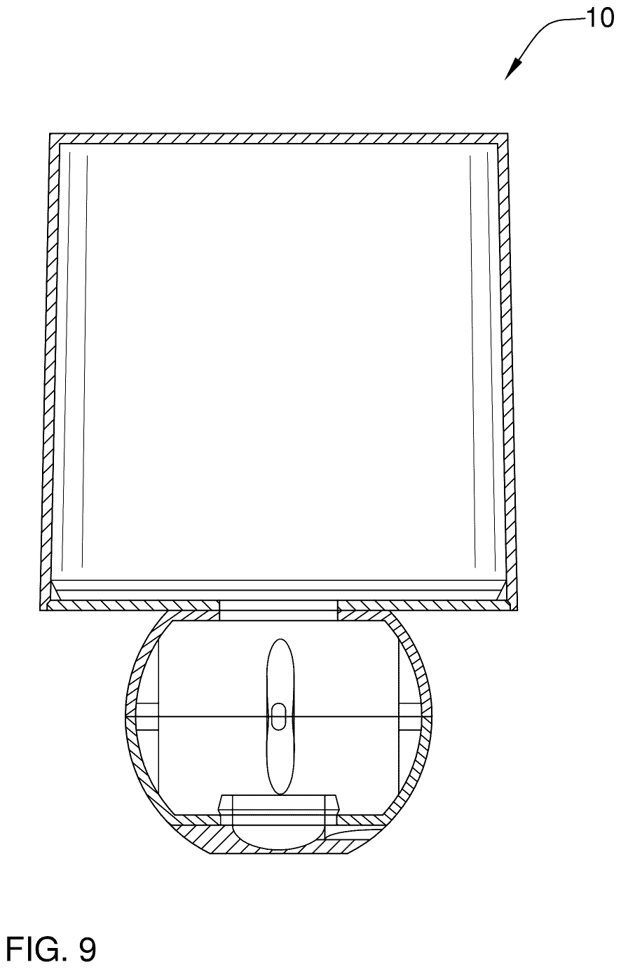

With reference now to the drawings, and in particular to FIGS. 1 through 10 thereof, a new lamp embodying the principles and concepts of an embodiment of the disclosure and generally designated by the reference numeral 10 will be described.

As best illustrated in FIGS. 1 through 10, the lamp 10 generally comprises a base 12, a lampshade 14, a grip structure 16, a socket 18, and a power cord 20. The base 12 has a top base surface 22 that is flat, a bottom base surface 24 that is flat, and a side base wall 26 that is spherical. The base 12 defines an interior base space 28. The base 12 includes a top base aperture 30 in the top base surface 22 and a bottom base aperture 32 in the bottom base surface 24. The lampshade 14 is coupled to the base 12. The lampshade 14 is cylindrical and defines an interior shade space 34. The lampshade 14 includes a top shade panel 36, a side shade wall 38 coupled to the top shade panel 36, and a bottom shade panel 40 detachably coupled to the side shade wall 38 and positioned abutting the top base surface 22. The bottom shade panel 40 includes a shade aperture 42 that is aligned with the top base aperture 30 to connect the interior shade space 34 and the interior base space 28. The grip structure 16 is coupled to the base 12 at the bottom base surface 24. The grip structure 16 includes a friction material 44 on an outer surface of the grip structure 16 to minimize sliding movement of the base 12 on a structure. The base 12 includes a channel 46 connected to the bottom base aperture 32.

The socket 18 is coupled to the lampshade 14 and the base 12. The socket 18 is positioned to pass through the shade aperture 42 and the top base aperture 30. The power cord 20 is coupled to the socket 18. The power cord 20 is positioned extending through the base 12 and out through the channel 46.

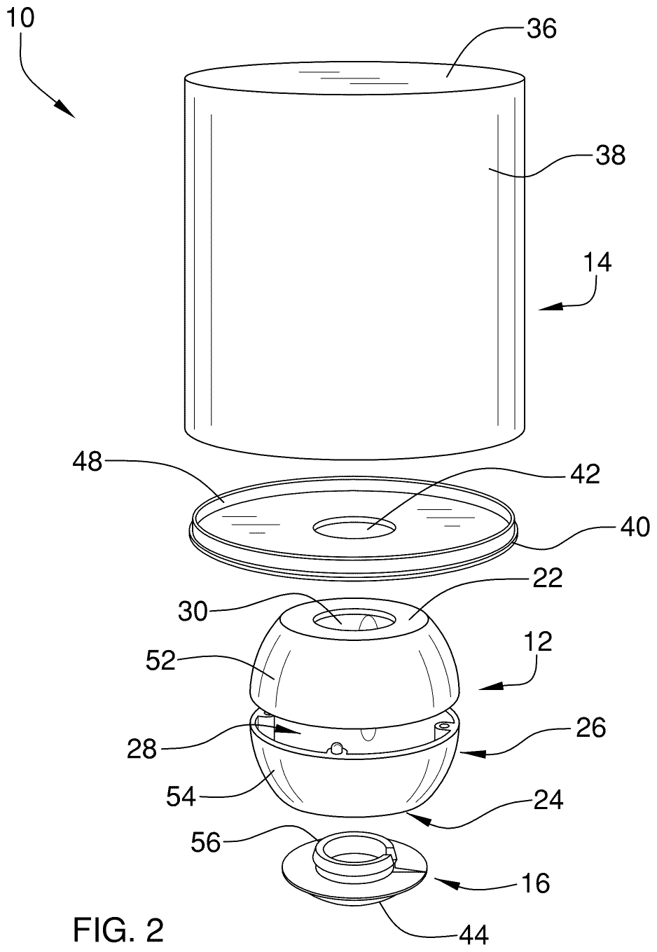

The bottom shade panel 40 is detachably coupled to the side shade wall 38 by a press fit. In the exemplary embodiment in FIG. 2, the bottom shade panel 40 includes a ring-shaped projection 48 designed to be inserted into the side shade wall 38 to detachably couple the bottom shade panel 40 to the side shade wall 38. This design allows easy removal of the side shade wall 38 and top shade panel 36 for replacement of a light bulb 62.

Each of the top shade panel 36, the side shade wall 38, and the base 12 is translucent for diffuse lighting. The bottom shade panel 40 is transparent for direct lighting.

Each of the lampshade 14 and the base 12 consists of a biodegradable plastic material. In the exemplary embodiment, the biodegradable plastic material is polylactic acid (PLA).

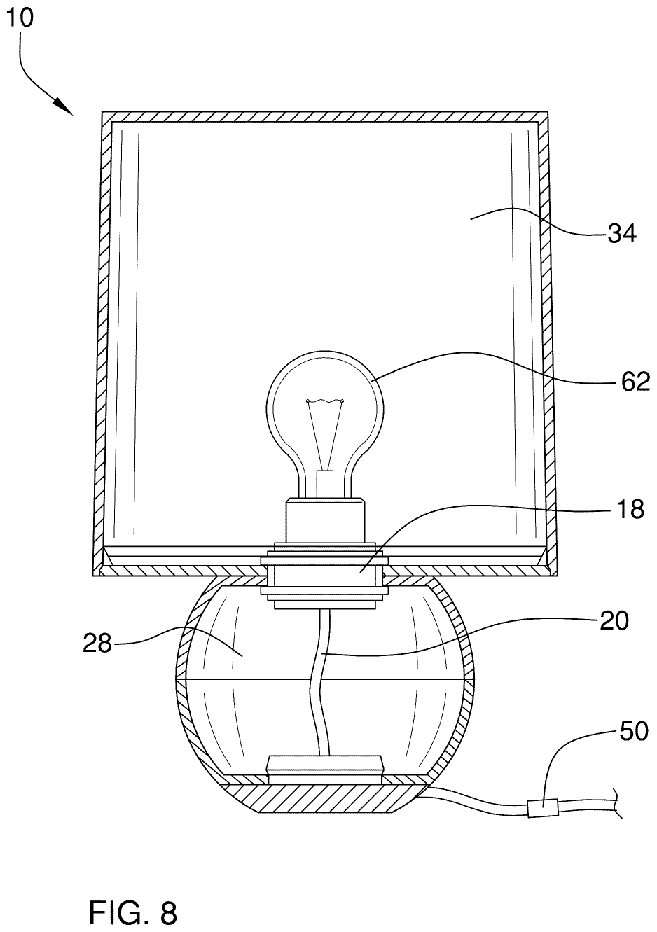

In the exemplary embodiment in FIG. 8, the lamp 10 further includes a switch 50. The switch 50 is coupled to the power cord 20. The switch 50 is designed to turn a light bulb 62 in the socket 18 on and off. The switch 50 is activatable by touch due to changes in capacitance.

The friction material 44 of the grip structure 16 is silicone.

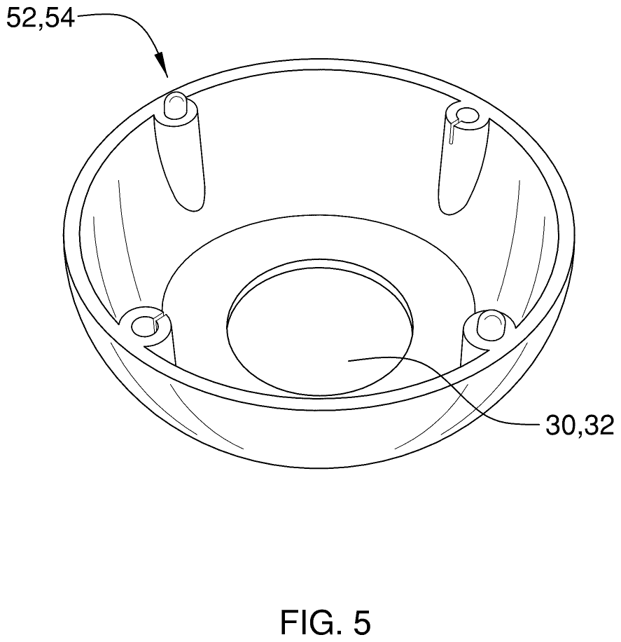

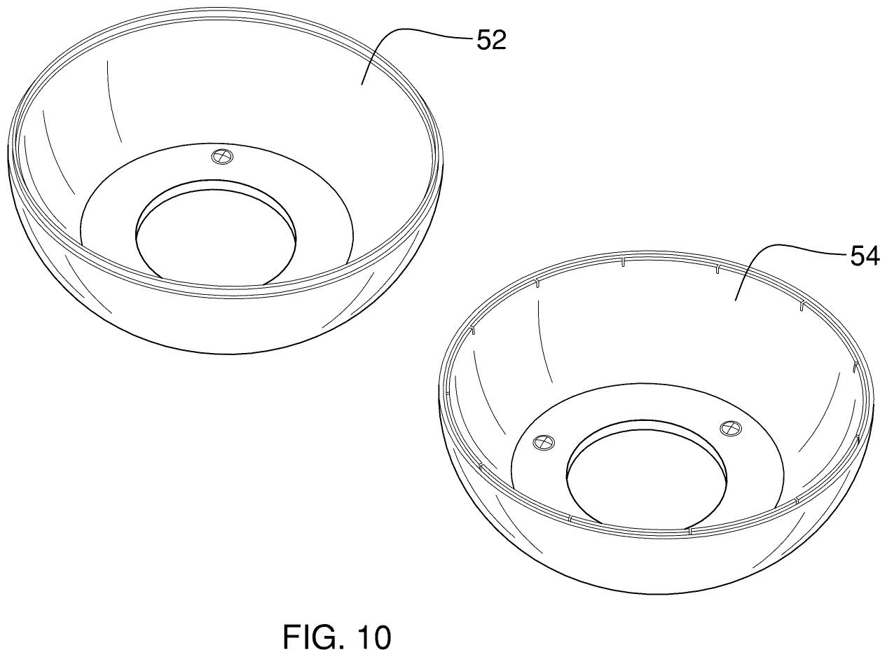

In the exemplary embodiment in FIG. 2, the base 12 is divided into a top base portion 52 and a bottom base portion 54 detachably coupled together. In an embodiment in FIGS. 2 and 5, the top base portion 52 and the bottom base portion 54 are connected by protrusions and receptacles. Alternatively, the top base portion 52 and bottom base portion 54 are connected by a tongue and groove as shown in FIG. 10. The grip structure 16 also includes a circular projection 56 for a press fit of the grip structure 16 and the base 12.

The lampshade 14, the base 12, and the grip structure 16 are coupled together in a flush manner to prevent light leaks.

The power cord 20 is braided and includes plant-derived rayon.

The lamp 10 can be made by injection molding. A mold is provided for the lampshade 14 and the base 12. The lampshade 14 and the base 12 are then injection molded at a temperature of less than 220 °C such that the lampshade 14 and the base 12 have a matte, non-glossy surface. In one possible embodiment, the temperature is in the range of 180 °C-220 °C. In another possible embodiment, the temperature is 200 °C

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lamp comprising:
a base, the base having a top base surface being flat, a bottom base surface being flat, and a side base wall being spherical, the base defining an interior base space, the base including a top base aperture in the top base surface and a bottom base aperture in the bottom base surface;
a lampshade, the lampshade being coupled to the base, the lampshade being cylindrical and defining an interior shade space, the lampshade including a top shade panel, a side shade wall being coupled to the top shade panel, and a bottom shade panel being detachably coupled to the side shade wall and positioned abutting the top base surface, the bottom shade panel including a shade aperture being aligned with the top base aperture to connect the interior shade space and the interior base space;
a grip structure, the grip structure being coupled to the base at the bottom base surface, the grip structure comprising a friction material on an outer surface of the grip structure to minimize sliding movement of the base on a structure, the base structure including a channel connected to the bottom aperture;
a socket, the socket being coupled to the lampshade and the base, the socket being positioned to pass through the shade aperture and the top base aperture; and
a power cord, the power cord being coupled to the socket, the power cord being positioned extending through the base and out through the channel.

2. The lamp of claim 1, wherein the bottom shade panel is detachably coupled to the side shade wall by a press fit;

3. The lamp of claim 1, wherein the bottom shade panel includes a ring-shaped projection configured to be inserted into the side shade wall to detachably couple the bottom shade panel to the side shade wall.

4. The lamp of claim 1, wherein:
each of the top shade panel, the side shade wall, and the base is translucent for diffuse lighting; and
the bottom shade panel is transparent for direct lighting.

5. The lamp of claim 1, wherein each of the lampshade and the base consists of a biodegradable plastic material.

6. The lamp of claim 5, wherein the biodegradable plastic material is polylactic acid (PLA);

7. The lamp of claim 1, further comprising a switch, the switch being coupled to the power cord, the switch being configured to turn a light bulb in the socket on and off, the switch being activatable by touch due to changes in capacitance.

8. The lamp of claim 7, wherein the switch is configured to selectively dim the light bulb.

9. The lamp of claim 7, wherein the switch comprises a biodegradable plastic material lined with die-cut adhesive conductive foil.

10. The lamp of claim 1, wherein the friction material of the grip structure is silicone.

11. The lamp of claim 1, wherein the base is divided into a top base portion and a bottom base portion detachably coupled together.

12. The lamp of claim 1, wherein the lampshade, the base, and the grip structure are coupled together in a flush manner to prevent light leaks.

13. The lamp of claim 1, wherein the power cord is braided and comprises plant-derived rayon.

14. A method of making the lamp of claim 1, comprising the steps of:
providing a mold for the lampshade and the base; and
injection molding the lampshade and the base at a temperature of less than 220 °C such that the lampshade and the base have a matte, non-glossy surface.

15. The method of claim 14, wherein the temperature is in the range of 180 °C -220 °C

16. The method of claim 15, wherein the temperature is 200°C.
